(19) United States
(12) Patent Application Publication
(10) Pub. No.: US 2006/0192819 A1
(43) Pub. Date: Aug. 31, 2006

(54) Recording apparatus

(75) Inventor: Takatsugu Doi, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/206,515

(22) Filed: Aug. 18, 2005

(30) Foreign Application Priority Data
Feb. 28, 2005 (JP) 2005-54790

(51) Int. Cl. B41J 2/175

(52) U.S. Cl. 347/85

(57) ABSTRACT

The invention provides a recording apparatus comprising an image forming liquid imparting device for imparting an image forming liquid to a recording medium, wherein an image forming liquid imparting port of the image forming liquid imparting device is provided with a supplying device for supplying at least one ionic liquid. The supplying device preferably mixes the ionic liquid with the image forming liquid in advance and supplies the ionic liquid together with the image forming liquid to the image forming liquid imparting port through the image forming liquid imparting device. Further, the amount of the ionic liquid to be mixed with the image forming liquid preferably exceeds the solubility of the ionic liquid to the image forming liquid.

### CROSS-REFERENCE TO RELATED APPLICATION

This application claims priority under 35 USC 119 from Japanese Patent Application No. 2005-54790, the disclosure of which is incorporated by reference herein.

### BACKGROUND OF THE INVENTION

1. Field of Invention

The present invention relates to a recording apparatus which uses a liquid composition such as an ink, and specifically relates to a recording apparatus which is preferable for ink jet recording method.

2. Description of the Related Art

Image forming liquid is generally ink. A water-based ink in which the main solvent component is water or an oil-based ink in which the main solvent component is an organic solvent are known as inks. It is known that water used in a water-based ink solvent evaporates with time since it has high vapor pressure, which causes the problem that coloring material in an ink solidifies.

Ink jet systems for ejecting ink from an ink ejection port formed of a nozzle, a slit or a porous film have been used in many printers due to their being small-sized and inexpensive. Of these ink jet systems, a piezo ink jet system for ejecting ink by utilizing the deformation of a piezoelectric unit and a thermal ink jet system for ejecting ink by utilizing the boiling phenomenon of an ink by way of thermal energy are excellent in a high resolution and a high-speed printing property.

In the case of ink for an ink jet, in particular, the nozzle diameter for ejecting ink is small, and a change of state of an ink tends to have a great influence on ejection thereof. When ink is left filled into a head for a long period, the main components of the solvent (such as water or an organic solvent) evaporate from the nozzle tip, whereby arises the problem of nozzle blockage. As a result, deterioration in picture quality is occasionally caused, either by non-ejection when ink is not ejected or by directional failure when the ejecting directional property of ink is distorted.

Application of a liquid sealing material to an ink ejection port surface (an ink imparting surface) has been proposed in Japanese Patent Application Laid-Open (JP-A) Nos. 2000-127383, 2001-158113 and 2001-301181.

The above-mentioned proposal enables the prevention of evaporation of the main components of the solvent in an ink (such as water or an organic solvent) by supplying a liquid sealing material to and thus sealing the ink ejection port surface.

The sealing, however, has not yet been sufficient to meet recent technological demands, and there remains a need for preventing evaporation of the main components of an ink solvent (such as water or an organic solvent) over a long period, and preventing deterioration of ejectability.

Recording apparatuses other than those employing the ink jet recording process are also similar in this respect, and need improvement.

### SUMMARY OF THE INVENTION

In consideration of the above, the invention provides a recording apparatus which suppresses the deterioration of ejectability by effectively preventing evaporation of the main components of a solvent in an image forming liquid (such as water or an organic solvent) over a long period.

Namely, the present invention provides a recording apparatus comprising an image forming liquid imparting device for imparting an image forming liquid to a recording medium, wherein an image forming liquid imparting port of the image forming liquid imparting device is provided with a supplying device for supplying at least one ionic liquid.

In a recording apparatus of the invention, an ionic liquid is employed as a liquid sealing material. The ionic liquid is supplied to an image forming liquid imparting port in an image forming liquid imparting device. Thus, the image forming liquid imparting port is sealed by the ionic liquid. The ionic liquid is in a liquid state at room temperature, and is a nonvolatile material having a very low vapor pressure. Thus, deterioration of ejectability can be suppressed by effectively preventing evaporation of the main components of solvents in image forming liquids (such as water or an organic solvent) over a long period.

In one embodiment, the the supplying device mixes the ionic liquid with the image forming liquid in advance and supplies the ionic liquid together with the image forming liquid to the image forming liquid imparting port through the image forming liquid imparting device.

The ionic liquid is mixed with an image forming liquid in advance and supplied to an image forming liquid imparting port through an image forming liquid imparting device while retained in a state (a free state) of substantially not being dissolved in an image forming liquid due to the differences in solubility and specific gravity of the ionic liquid relative to the image forming liquid. Thus, the image forming liquid imparting port is sealed by an ionic liquid in a free state.

In the above embodiment, the amount of the ionic liquid to be mixed with the image forming liquid preferably exceeds the solubility of the ionic liquid to the image forming liquid. Further, it is preferable that the amount of the ionic liquid that is soluble in 100 g of the image forming liquid is less than about 5 g.

Thus, the ionic liquid is supplied to the image forming liquid imparting port through the image forming liquid imparting device while ensuring that it is retained in a state (a free state) of not being dissolved in the image forming liquid.

### BRIEF DESCRIPTION OF THE DRAWINGS

FIG. 1 is a perspective view showing the structure of an appearance according to a first embodiment of the ink jet recording apparatus in accordance with the invention.

FIG. 2 is a perspective view showing the basic structure of an inner part in the ink jet recording apparatus shown in FIG. 1

FIG. 3 is a schematic view showing the vicinity of a liquid seal apparatus of an ink jet recording apparatus according to a first embodiment of the invention.

FIG. 4 is a schematic view showing the vicinity of a liquid seal apparatus of an ink jet recording apparatus according to a second embodiment of the invention.

FIG. 5 is a schematic view showing an ink jet recording apparatus according to a third embodiment of the invention.

FIG. 6 is a perspective view showing the basic structure of an inner part of the ink jet recording apparatus in FIG. 5.

FIG. 7 is a schematic view showing the vicinity of a liquid seal apparatus of an ink jet recording apparatus according to a third embodiment of the invention.

FIG. 8 is a schematic view showing the vicinity of a liquid seal apparatus of an ink jet recording apparatus according to a fourth embodiment of the invention.

### DETAILED DESCRIPTION OF THE INVENTION

A preferred embodiment of the ink jet recording apparatus according to the invention will be described below in detail with reference to the drawings. In the drawings, members having substantially the same functions have the same reference numerals and repetitive description will be omitted.

### First Embodiment of the Invention

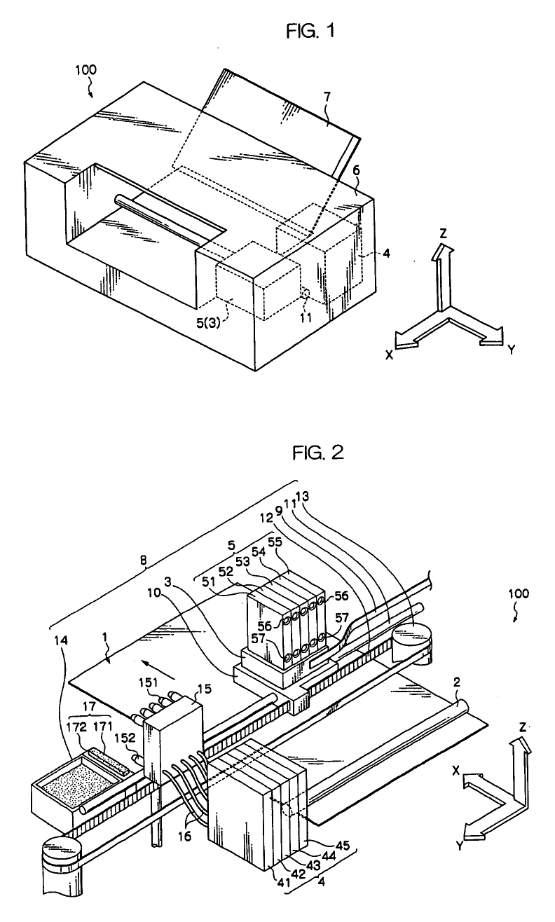

FIG. 1 is a perspective view showing the structure of an appearance according to a first embodiment of the ink jet recording apparatus in accordance with the invention. FIG. 2 is a perspective view showing the basic structure of an inner part in the ink jet recording apparatus (which will be hereinafter referred to as a recording apparatus) in FIG. 1.

A recording apparatus 100 according to the embodiment has such a structure as to be operated to form an image based on an ordinary ink jet recording method. More specifically, as shown in FIGS. 1 and 2, the recording apparatus 100 is mainly constituted by an external cover 6, a tray 7 capable of mounting a recording medium 1 such as a plain paper in a predetermined amount, a delivery roller (delivery means) 2 for delivering the recording medium 1 every sheet into the recording apparatus 100, an image forming portion 8 (image forming means) for ejecting an ink and a liquid composition to the surface of the recording medium 1, thereby forming an image, and a main tank 4 for supplying inks and treating solution to each sub tanks in the sub tank 5.

The delivery roller 2 is a paper feeding mechanism constituted by a pair of rollers provided rotatably in the recording apparatus 100, and serves to interpose the recording medium 1 set to the tray 7 and to deliver the recording medium 1 in a predetermined amount into the apparatus 100 every sheet in a predetermined timing.

The image forming portion 8 forms an image with an ink onto the surface of the recording medium 1. The image forming portion 8 is mainly constituted by a recording head 3 (image forming liquid imparting device), a sub ink tank 5, a feeding signal cable 9, a carriage 10, a guide rod 11, a timing belt 12, a driving pulley 13, and a maintenance unit 14.

The recording head 3 (an image forming liquid imparting device) is provided for ejecting ink and treating solution supplied from the sub ink tank 5 to the recording medium 1, and is provided on a surface opposite to the recording medium 1 with a nozzle (not shown) as an ejection port (an image forming liquid imparting port) for the ink and treating solution.

The sub ink tank 5 has ink tanks 51, 52, 53, 54 and 55 which store inks or liquid compositions having different colors from each other so as to be ejected. These accommodate, for example, a black ink (K), a yellow ink (Y), a magenta ink (M), a cyan ink (C), and a treating solution. Of course, it is not necessary to provide an ink tank for the treating solution separately when the treating solution is not used or when the treating solution contains a coloring material.

Each tank in the sub ink tank 5 is provided with an exhaust hole 56 and a refilling hole 57. When the recording head 3 moves to a waiting position (or a refilling position), a pin for exhausting 151 and a pin for refilling 152 of a refilling apparatus 15 are inserted into the exhaust hole 56 and the refilling hole 57 respectively, whereby the sub ink tank 5 and the refilling apparatus 15 can be connected. The refilling apparatus 15 is connected to the main ink tank 4 through refilling tube(s) 16, and supplies ink and treating solution from the main ink tank 4 to each tank in the sub ink tank 5 through the refilling hole 57.

Here, the main ink tank 4 also has ink tanks 41, 42, 43, 44 and 45 which store inks having different colors and a treating solution. These are filled with, for example, a black ink (K), a yellow ink (Y), a magenta ink (M) and a cyan ink (C) as first liquids, and treating solution as a second liquid, and are each removably stored in the recording apparatus 100.

Examples of an ink tank which can be used as the main ink tank 4 include the one described in JP-A No. 2001-138541.

As shown in FIG. 2, furthermore, the feeding signal cable 9 and the sub ink tank 5 are connected to the recording head 3. When external image recording information is input from the feeding signal cable 9 to the recording head 3, the recording head 3 sucks an ink in a predetermined amount from each of the ink tanks and ejects the same ink onto the surface of the recording medium based on the image recording information. The feeding signal cable 9 also plays a part in the supply of a necessary power for driving the recording head 3 to the recording head 3 in addition to the image recording information.

Moreover, the recording head 3 is provided and held on the carriage 10, and the guide rod 11 and the timing belt 12 connected to the driving pulley 13 are connected to the carriage 10. By such a structure, the recording head 3 can also be moved in a direction Y (a scanning direction) which is parallel with the surface of the recording medium 1 and is perpendicular to a delivery direction X (a sub-scanning direction) of the recording medium 1 along the guide rod 11.

The recording apparatus 100 comprises control means (not shown) for regulating the driving timing of the recording head 3 and the driving timing of the carriage 10 based on image recording information. Consequently, it is possible to continuously form an image based on the image recording information in a predetermined region over the surface of the recording medium 1 to be delivered at a predetermined speed along with the delivery direction X.

The maintenance unit 14 is connected to a pressure reducing device (not shown) through a tube. Furthermore, the maintenance unit 14 is connected to the nozzle portion of the recording head 3 and has the function of setting the inside of the nozzle of the recording head 3 into a pressure reducing state, thereby sucking an ink from the nozzle of the recording head 3. By providing the maintenance unit 14, it is possible to remove an excessive ink stuck to the nozzle during the operation of the recording apparatus 100 if necessary or to suppress the evaporation of the ink from the nozzle in an operation stop state.

A liquid seal apparatus 17 (an ionic liquid supplying means: a coating means) is provided on a side of the maintenance unit 14. The liquid seal apparatus 17 is composed of an ionic liquid impregnating member 171 for applying ionic liquid to a nozzle of the recording head 3, and a bearing member 172 that supports the ionic liquid impregnating member 171. The ionic liquid impregnating member 171 is provided so that the recording head 3 contacts therewith when the recording head 3 moves upward of the maintenance unit 14. The ionic liquid impregnating member 171 is impregnated with an ionic liquid and contacts with a nozzle face (an opening of a nozzle) of the recording head 3 so that a layer containing the ionic liquid is formed on the nozzle face to seal the opening of the nozzle.

Component materials of the ionic liquid impregnating member 171 are not particularly limited as long as they can be impregnated with ionic liquids, and examples thereof include a fibrous body and a porous body. Examples of the fibrous body include nonwoven cloth, woven cloth, knitted cloth and composites thereof. Examples of the porous body include products manufactured by treating natural rubber (NR), polychloroprene rubber (CR), acrylonitrile-butadiene rubber (NBR), soft polyurethane (PU) foam, polystyrene, polyvinyl chloride (PVC), polyethylene (PE), polypropylene (PP), ethylene-vinyl acetate copolymer (EVA), polyurethane, phenolic resin, urea resin, epoxy resin or the like by drawing (elongation), rolling and/or foaming.

A supplying apparatus (not shown) for supplying an ionic liquid to the ionic liquid impregnating member 171 may be further provided for maintaining a state where the ionic liquid impregnating member 171 is abundantly impregnated with the ionic liquid.

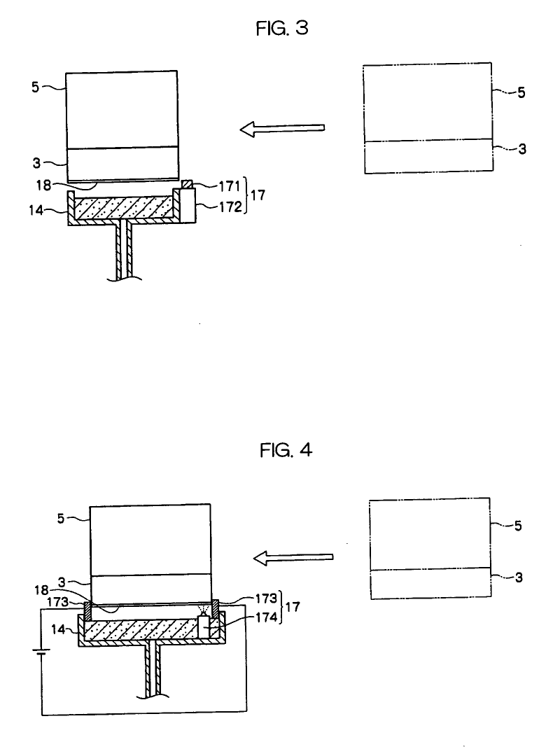

The recording apparatus 100 according to the embodiment operates in accordance with an ordinary ink jet recording method so as to form an image, and thereafter, the recording head 3 moves to the waiting position above the maintenance unit 14 as shown in FIG. 3. Here, the nozzle face of the recording head 3 is rubbed with the ionic liquid impregnating member 171 (the liquid seal apparatus 17), and an ionic liquid layer 18 is formed on the nozzle face of the recording head 3. Thus, the opening of the nozzle is sealed.

When performing an operation to remove excessive ink adhering to the nozzle at the maintenance unit 14, the recording head 3 is moved again after being moved to the maintenance unit 14, in order to rub the nozzle face of the recording head 3 with the ionic liquid impregnating member 171 (the liquid seal apparatus 17), and thus form the ionic liquid layer 18 on the nozzle face of the recording head 3.

In this manner, in the recording apparatus 100 according to the embodiment, the opening of the nozzle is sealed with the ionic liquid by applying the ionic liquid as a liquid sealing material to the nozzle face of the recording head 3.

### Second Embodiment of the Invention

FIG. 4 is a schematic view showing the vicinity of a liquid seal apparatus of an ink jet recording apparatus according to a second embodiment of the invention.

The ink jet recording apparatus according to the embodiment provides an aspect where the ionic liquid is applied to the nozzle face of the recording head due to the effect of an electric field.

In the ink jet recording apparatus according to the embodiment, the maintenance unit 14 is provided with a liquid seal apparatus 17 composed of a pair of electrodes 173 and an ionic liquid ejecting member 174 for ejecting ionic liquid. The pair of electrodes 173 are provided so that the lower ends of both opposite sides of the recording head 3 are covered when the recording head 3 moves to the waiting position above the maintenance unit 14. The ionic liquid ejecting member 174 is provided so as to be capable of ejecting the ionic liquid to at least a part (for example, an end) of the nozzle face of the recording head 3.

Aside from this, the structure is the same as in the first embodiment, and thus, description thereof is omitted.

The recording apparatus according to the embodiment operates in accordance with an ordinary ink jet recording method so as to form an image, and thereafter, the recording head 3 moves to the waiting position above the maintenance unit 14 as shown in FIG. 4. The ionic liquid ejecting member 174 ejects the ionic liquid to at least a part of the nozzle face of the recording head 3, and additionally voltage is applied between the pair of electrodes 173. Thus, an electric field is generated in a direction which is parallel to the nozzle face. Ionic liquid is charged with electricity. Therefore, due to the function of this electric field, the ejected ionic liquid is evenly spread on at least a part of the nozzle face (or the ionic liquid is ejected so as to spread on at least a part of the nozzle face) to cover the whole nozzle face and form the ionic liquid layer 18. Thus, the opening of the nozzle is sealed.

In this manner, in the recording apparatus according to the embodiment, the opening of the nozzle is sealed with the ionic liquid by applying the ionic liquid as a liquid sealing material to the nozzle face of the recording head 3.

### Third Embodiment of the Invention

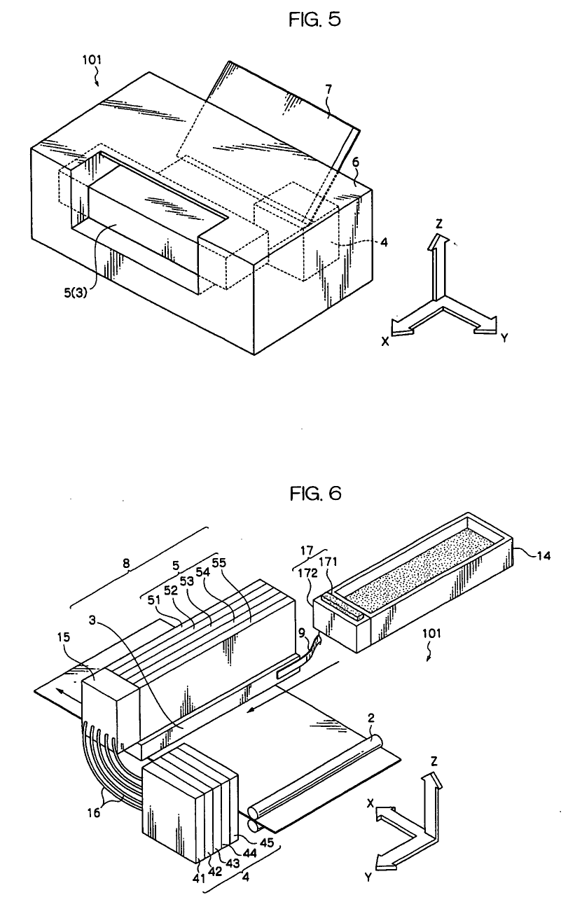

FIG. 5 is a perspective view showing the structure of an appearance according to a third embodiment of the ink jet recording apparatus according to the invention. FIG. 6 is a perspective view showing the basic structure of an inner part of the ink jet recording apparatus (which will be hereinafter referred to as a recording apparatus) in FIG. 5.

An image forming apparatus 101 according to the embodiment has such a structure as to be operated to form an image based on an ordinary ink jet recording method. The image forming apparatus 101 shown in FIGS. 5 and 6 includes a recording head 3 having a width which is equal to or greater than the width of a recording medium 1, does not include a carriage mechanism, and is constituted by a paper feeding mechanism (which is a delivery roller 2 in the embodiment but may be a paper feeding mechanism of a belt type, for example) in a sub-scanning direction (the delivery direction of the recording medium 1: the direction of an arrow X). Since the image forming apparatus of the configuration collectively carries out printing in the transverse direction (scanning direction) of the recording medium 1 by means of the recording medium 3, the structure of the apparatus can be more simplified and a printing speed is more increased than a type having a carriage mechanism.

The maintenance unit 14 is provided with a drive unit (not shown) since the maintenance unit 14 has no carriage mechanisms. The system is constituted so that the maintenance unit 14 moves to below the recording head 3 during standby.

A group of nozzles for ejecting each color (also including treating solution) are also arrayed in a sub-scanning direction (the delivery direction of recording medium 1: the direction of an arrow X) in the same manner that main ink tanks 51, 52, 53, 54 and 55 are sequentially arrayed in the sub-scanning direction (not shown).

Aside from this, the structure is the same as in the first embodiment and, therefore, description thereof is omitted.

The drawings show a structure in which the sub ink tank 5 is constantly connected to the refilling apparatus 15 since the recording head 3 does not move. However, a structure in which the sub ink tank 5 is connected to the refilling apparatus 15 during refilling of ink may be also employed in the invention.

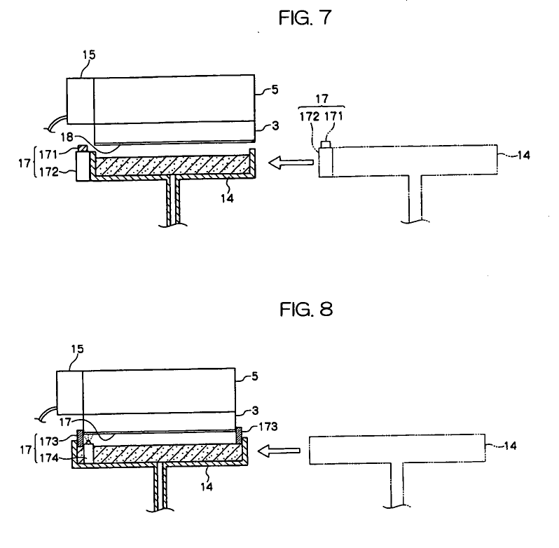

A recording apparatus 101 according to the embodiment operates in accordance with an ordinary ink jet recording method so as to form an image, and thereafter as shown in FIG. 7, the maintenance unit 14 moves to below the recording head 3. On this occasion, the nozzle face of the recording head 3 is rubbed with the ionic liquid impregnating member 171 (the liquid seal apparatus 17), and the ionic liquid layer 18 is formed on the nozzle face of the recording head 3. Thus, the opening of the nozzle is sealed.

When performing an operation to remove excessive ink adhering to the nozzle at the maintenance unit 14, the recording head 3 is moved again after being moved to below the maintenance unit 14, in order to rub the nozzle face of the recording head 3 with the ionic liquid impregnating member 171 (the liquid seal apparatus 17), and then form the ionic liquid layer 18 on the nozzle face of the recording head 3.

In this manner, in the recording apparatus 101 according to the embodiment, the opening of the nozzle is sealed with the ionic liquid by applying the ionic liquid as a liquid sealing material to the nozzle face of the recording head 3.

### Fourth Embodiment of the Invention

FIG. 8 is a schematic view showing the vicinity of a liquid seal apparatus of an ink jet recording apparatus according to a fourth embodiment of the invention.

The ink jet recording apparatus according to the embodiment provides an aspect in which the ionic liquid is applied to the nozzle face of the recording head due to the effect of an electric field.

In the ink jet recording apparatus according to the embodiment, the maintenance unit 14 is provided with a liquid seal apparatus 17 composed of a pair of electrodes 173 and an ionic liquid ejecting member 174 for ejecting ionic liquid. The pair of electrodes 173 are provided so as to cover the lower ends of both opposite sides of a recording head 3 when a maintenance unit 14 moves to below a recording head 3. The ionic liquid ejecting member 174 is provided so as to be capable of ejecting the ionic liquid to at least a part (for example, an end) of the nozzle face of the recording head 3.

Aside from this, the structure is the same as in the third embodiment and, therefore, description thereof is omitted.

The ink jet recording apparatus according to the embodiment operates in accordance with an ordinary ink jet recording method so as to form an image, and thereafter, the maintenance unit 14 moves to below the recording head 3 as shown in FIG. 8. The ionic liquid ejecting member 174 ejects the ionic liquid to at least a part of the nozzle face of the recording head 3, and additionally voltage is applied between the pair of electrodes 173. Thus, an electric field is generated in a direction which is parallel to the nozzle face. Ionic liquid is charged with electricity. Therefore, due to the function of this electric field, the ejected ionic liquid is evenly spread on at least a part of the nozzle face (or the ionic liquid is ejected so as to spread on at least a part of the nozzle face) to cover the whole nozzle face and form the ionic liquid layer 18. Thus, the opening of the nozzle is sealed.

In this manner, in the ink jet recording apparatus according to the embodiment, the opening of the nozzle is sealed with the ionic liquid by applying the ionic liquid as a liquid sealing material to the nozzle face of the recording head 3.

### Fifth Embodiment of the Invention

An ink jet recording apparatus according to the embodiment provides an aspect in which the ionic liquid is mixed with ink(s) and treating solution in advance, and supplied to the opening of the nozzle through the recording head with the ink and treating solution. The ink jet recording apparatus according to the first to fourth embodiments can be applied to this ink jet recording apparatus except for the liquid seal apparatus 17.

In the ink jet recording apparatus according to the embodiment, the ionic liquid is added to the ink and treating solution in advance and stored in the main ink tank 4, and then supplied to the recording head 3 through the sub ink tank 5 accompanied with the ink and treating solution by the refilling apparatus 15. When the ink jet recording apparatus according to the embodiment operates in accordance with an ordinary ink jet recording method, the ink and treating solution are each ejected for forming an image, whereafter the ionic liquid is supplied to the opening of the nozzle with the ink and treating solution. Ionic liquid is also ejected on the occasion of forming an image; however, this has no influence on image quality.

Here, the ionic liquid is supplied to the opening of the nozzle while retained in a state (a free state) of substantially not being dissolved in the ink and treating solution due to differences in the solubility and specific gravity of the ionic liquid relative to the ink and treating solution. This free ionic liquid seals the opening of the nozzle.

Here, in order to guarantee that the ionic liquid mixed with the ink and treating solution remains in a free state, the amount of the ionic liquid to be mixed with the ink and treating solution is preferably in excess of a soluble amount, based on the solubility of the ionic liquid in ink and treating solution. Specifically, the added amount of the ionic liquid is preferably about 1.5 or more times the amount of the soluble amount thereof, and is more preferably about two or more times the amount of the soluble amount thereof. It is found that a reduced quantity added (that is, the supplied quantity to an opening of a nozzle) tends to lower the seal function of the opening of the nozzle and impair the effect of preventing evaporation of the ink and treating solution.

The solubility, namely, the amount of the ionic liquid that is soluble in 100 g of the ink and treating solution, is preferably less than about 5 g, more preferably less than about 3 g, and still more preferably less than about 1 g for the same reason. When the solubility of ionic liquid in 100 g of ink is 5 g or more, the ionic liquid may be dissolved in the ink and treating solution, and thus the ionic liquid may not be able to be sufficiently supplied to the opening of a nozzle in a free state. As a result thereof, it is found that the effect of preventing evaporation of the ink and treating solution from the opening of the nozzle tends to be reduced.

The specific gravity of the ionic liquid is preferably higher than that of the ink and treating solution in cases where the nozzle points downward (downward in the gravitational direction), while the specific gravity of the ionic liquid is preferably lower than that of the ink and treating solution in cases where the nozzle points upward (upward in the gravitational direction). Thus, in either case, the ionic liquid is rendered free from the ink and treating solution, and the opening of a nozzle is effectively sealed with the ionic liquid.

In each of the embodiments described above, the ionic liquid is supplied (applied, and supplied together with the ink and treating solution) as a liquid sealing material to the nozzle face (the opening of the nozzle) of the recording head 3, and then the opening of the nozzle is sealed with the ionic liquid.

With regard to the ionic liquid to be used as the liquid sealing material, it is known that a salt thereof is generally solid at a normal temperature and melted by heating to several hundreds of degrees. On the other hand, a so-called ionic liquid, which is in a liquid state at a normal temperature when it is a predetermined combination of organic positive ions and negative ions, has been discovered. The reason why this ionic liquid is in a liquid state at a temperature around normal temperature is assumed to relate to the size of the ion(s) therein and electrostatic interactions between the ions therein. In addition, the ionic liquid has characteristics of low vapor pressure and nonvolatility, as well as nonflammability and incombustibility. These are assumed to be because the ions therein are constrained by electrostatic interactions therebetween.

As is described above, the ionic liquid has the characteristics of low vapor pressure and nonvolatility. Therefore, the use of the ionic liquid as a liquid sealing material effectively prevents evaporation of the main components of solvents (such as water or an organic solvent) in image forming liquids (the ink and treating solution) over a long period, and thus the deterioration of ejectability is suppressed.

The use of a water-based ink as the ink in the invention can prevent compositional changes and nozzle clogging due to evaporation of water-based solvent therein. The use of an oil-based ink as the ink in the invention can prevent compositional changes and clogging, as well as deterioration of environmental conditions due to evaporation of organic solvent therein.

Further, the ionic liquid is superior in environmental protection and safety since it has characteristics of nonvolatility as well as nonflammability or flame resistance. The ionic liquid has a low influence in a mixture with ink. Therefore, there is no need to remove the ionic liquid applied to the nozzle face (the opening of the nozzle), and thus the recording apparatus can have a simple structure.

In particular, as compared with the aspects of the first and second embodiments of Partial Width Array (PWA) having a scanning mechanism (the carriage 10) and a sub-scanning mechanism (the delivery roller 2), the aspects of the third and fourth embodiments of Full Width Array (FWA) for printing one pass corresponding to the width of a sheet of paper provide a nozzle arrayed with high density (a large number of nozzles) and, therefore, evaporation of the main components of solvents (such as water or an organic solvent) in the ink is notable in this aspect. Accordingly, application of the invention is effective.

An example of applying a two-part liquid system where the ink and treating solution are employed as the image forming liquid has been described in each of the above-mentioned embodiments; however, a one-part liquid system where only ink is employed may also be applied in the invention.

Hereinafter, explanations are given to the ionic liquid used in the invention. The ionic liquid is a compound which consists of an organic cation and an anion and has a melting point at 20° C. or lower. Examples of the organic cation include imidazolium ions, pyridinium ions, peprtidinium ions, quaternary ammonium ions, and phosphonium ions.

Imidazolium salts are represented by the following Formula (1).

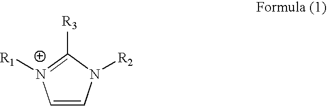

In Formula (1), each of R₁ to R₃ independently represents a hydrogen atom, an alkyl group or an alcoxy group, in which the alkyl group and the alcoxy group preferably have 1 to 20 carbon atoms, and the number of carbon atoms are particularly preferably in a range from 1 to 8. Specific examples of the imidazolium salts include 1-ethyl-3-methylimidazolium salts, 1-buthyl-3-methylimidazolium salts, 1-hexyl-3-methylimidazolium salts, 1-octhyl-3-methylimidazolium salts, 1-decyl-3-methylimidazolium salts, 1-dodecyl-3-methylimidazolium salts, 1-tetradecyl-3-methylimidazolium salts, 1-hexadecyl-3-methylimidazolium salts, 1-octadecyl-3-methylimidazolium salts, 1-ethyl-2,3-dimethylimidazolium salts, 1-buthyl-2,3-dimethylimidazolium salts, 1-hexyl-2,3-dimethylimidazolium salts and the like. Particularly preferable examples among them include 1-ethyl-3-methylimidazolium salts and 1-buthyl-3-methylimidazolium salts.

Pyridinium salts are represented by the following Formula (2).

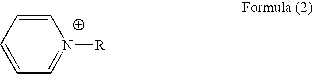

In Formula (2), R represents a hydrogen atom, an alkyl group or an alcoxy group, in which the alkyl group and the alcoxy group preferably have 1 to 20 carbon atoms, and the number of carbon atoms are particularly preferably in a range from 1 to 8.

Specific examples of the pyridinium salts include 1-ethylpyridinium salts, 1-buthylpyridinium salts, 1-ethylpyridinium salts, and 1-hexylpyridinium salts. Particularly preferable examples among them include 1-ethylpyridinium salts and 1-buthylpyridinium salts.

Quaternary ammonium salts are represented by the following Formula (3).

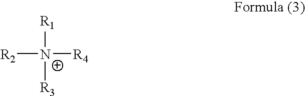

In Formula (3), each of R₁ to R₄ independently represents a hydrogen atom, an alkyl group or an alcoxy group, in which the alkyl group and the alcoxy group preferably have 1 to 20 carbon atoms, and the number of carbon atoms are particularly preferably in a range from 1 to 8.

Specific examples of the quaternary ammonium salts include trimethyl-hexyl ammonium salts, N,N-diethyl-N-methyl-N-(2-methoxyethyl)ammonium salts, and trimethyl-octhyl ammonium salts. Particularly preferable examples among them include N,N-diethyl-N-methyl-N-(2-methoxyethyl)ammonium salts.

Piperidinium salts are represented by the following Formula (4).

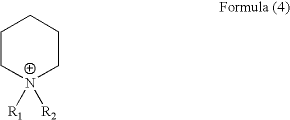

In Formula (4), each of R₁ and R₂ independently represents a hydrogen atom or an alkyl group, in which the alkyl group preferably has 1 to 20 carbon atoms, and the number of carbon atoms is particularly preferably in a range from 1 to 8.

The ionic liquid may be a Zwitterionic liquid, in which a salt represented by any one of Formulae (1) to (4) includes a carboxylic acid group or a sulfonic acid group in the alkyl group thereof.

Examples of the ionic liquid further include pyrrolinium salts, phenylindolium salts, alkylindolium salts, alkylcarbazolium salts, pyrazolium salts, pyrrolidinium salts and the like.

Examples of the organic cation which are preferable in view of possibility to control a melting point of a compound by altering an anion with which the compound is formed include imidazolium ions, pyridinium ions, piperidinium ions, and quaternary ammonium ions which have a long alkyl chain. Specific examples thereof include 1-ethyl-3-methylimidazolium salts, 1-buthyl-3-methylimidazolium salts, 1-hexyl-3-methylimidazolium salts, 1-octhyl-3-methylimidazolium salts, 1-decyl-3-methylimidazolium salts, 1-dodecyl-3-methylimidazolium salts, 1-tetradecyl-3-methylimidazolium salts, 1-hexadecyl-3-methylimidazolium salts, 1-octadecyl-3-methylimidazolium salts, 1-buthyl-2,3-dimethylimidazolium salts, 1-buthylpyridinium salts, 1-hexylpyridinium salts, trimethyoctyl ammonium salts, piperidinium salts and the like.

Examples of the anion include a lithium ion, bromine ion, chlorine ion, lactate ion, hexafluorophosphate, tetrafluoroborate, bis(trifluoromethanesulfonyl)imide, trifluoromethanesulfonate and the like.

Examples of the anion which are preferable in view of possibility to ascertain safety accounting for toxicity of materials and to control a melting point of a compound by altering a cation with which the compound is formed include a lithium ion, bromine ion, chlorine ion, lactate ion, hexafluorophosphate, bis(trifluoromethanesulfonyl)imide, trifluoromethanesulfonate and the like, and preferable examples among them include a lithium ion, bromine ion, chlorine ion, and lactate ion.

Specific examples of the ionic liquid include 1-ethyl-3-methylimidazolium bromide, 1-ethyl-3-methylimidazolium chloride, 1-ethyl-3-methylimidazolium lactate, 1-ethyl-3-methylimidazolium hexafluorophosphate, 1-buthyl-3-methylimidazolium chloride, 1-buthyl-3-methylimidazolium bis(trifluoromethanesulfonyl)imide, 1-buthyl-3-methylimidazolium hexafluorophosphate, 1-buthyl-3-methylimidazolium tetrafluoroborate, 1-buthyl-3-methylimidazolium trifluoromethanesulfonate, 1-buthyl-3-methylimidazolium lactate, 1-hexyl-3-methylimidazolium bromide, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium trifluoromethanesulfonate, 1-octyl-3-methylimidazolium chloride, 1-octyl-3-methylimidazolium hexafluorophosphate, 1-decyl-3-methylimidazolium chloride, 1-dodecyl-3-methylimidazolium chloride, 1-hexadecyl-3-methylimidazolium chloride, 1-ocadecyl-3-methylimidazolium chloride, 1-ethyl-2,3-dimethylimidazolium bromide, 1-ethyl-2,3-dimethylimidazolium chloride, 1-buthyl-2,3-dimethylimidazolium chloride, 1-buthyl-2,3-dimethylimidazolium bromide, 1-buthyl-2,3-dimethylimidazolium tetrafluoroborate, 1-hexyl-2,3-dimethylimidazolium bromide, 1-hexyl-2,3-dimethylimidazolium chloride, 1-hexyl-2,3-dimethylimidazolium tetrafluoroborate, 1-hexyl-2,3-dimethylimidazolium trifluoromethanesulfonate, 1-ethylpyridinium bromide, 1-ethylpyridinium chloride, 1-buthylpyridinium bromide, 1-buthylpyridinium chloride, 1-buthylpyridinium hexafluorophosphate, 1-buthylpyridinium trifluoromethanesulfonate, 1-hexylpyridinium bromide, 1-hexylpyridinium chloride, 1-hexylpyridinium hexafluorophosphate, 1-hexylpyridinium tatrafluoroborate, 1-hexylpyridinium trifluoromethanesulfonate, N,N-diethyl-N-methyl-N-(2-methoxyethyl)ammonium tetrafluoroborate, N,N-diethyl-N-methyl-N-(2-methoxyethyl)ammonium bis(trifluoromethanesulfonyl)imide, Trimethylhexylammonium bis(trifluoromethanesulfonyl)imide, Trimethyloctylammonium bis(trifluoromethanesulfonyl)imide, Trimethylpropylammonium bis(trifluoromethanesulfonyl)imide, 2-methyl-1-pyrroliniumhezafluoroborate, 1-ethyl-2-phenylindolium hexafluoroborate, 1,2-dimethylindolium hexafluoroborate, 1-ethylcarbazolium hexafluoroborate, 1-methylpyrazolium hexafluoroborate, 1-methylpyrrolidinium hexafluoroborate, and the like.

Following compounds are preferable as the ionic liquid in view of possibility to ascertain safety accounting for toxicity of materials and ink ejectability. A viscosity of an ink provides an effect to the ejectability of the ink specifically when an ink jet recording method is used. Namely, specific preferable examples of such compounds include 1-ethyl-3-methylimidazolium lactate, 1-ethyl-3-methylimidazolium hexafluorophosphate, 1-buthyl-3-methylimidazolium bis(trifluoromethanesulfonyl)imide, 1-buthyl-3-methylimidazolium hexafluorophosphate, 1-buthyl-3-methylimidazolium trifluoromethanesulfonate, 1-buthyl-3-methylimidazolium lactate, 1-hexyl-3-methylimidazolium hexafluorophosphate, 1-hexyl-3-methylimidazolium trifluoromethanesulfonate, 1-octyl-3-methylimidazolium chloride, 1-octyl-3-methylimidazolium hexafluorophosphate, 1-decyl-3-methylimidazolium chloride, 1-dodecyl-3-methylimidazolium chloride, 1-hexadecyl-3-methylimidazolium chloride, 1-ocadecyl-3-methylimidazolium chloride, 1-hexyl-2,3-dimethylimidazolium bromide, 1-hexyl-2,3-dimethylimidazolium chloride, 1-hexyl-2,3-dimethylimidazolium trifluoromethanesulfonate, 1-buthylpyridinium bromide, 1-buthylpyridinium chloride, 1-buthylpyridinium hexafluorophosphate, 1-buthylpyridinium trifluoromethanesulfonate, 1-hexylpyridinium bromide, 1-hexylpyridinium chloride, 1-hexylpyridinium hexafluorophosphate, 1-hexylpyridinium trifluoromethanesulfonate, N,N-diethyl-N-methyl-N-(2-methoxyethyl)ammonium bis(trifluoromethanesulfonyl)imide, Trimethylhexylammonium bis(trifluoromethanesulfonyl)imide, Trimethyloctylammonium bis(trifluoromethanesulfonyl)imide, and Trimethylpropylammonium bis(trifluoromethanesulfonyl)imide.

The ionic liquid is a compound which consists of an organic cation and an anion, and preferably is a compound having a melting point of about 25° C. or lower. If the melting point exceeds about 25° C., the ionic liquid may not be properly imparted as the liquid sealing material since such the ionic liquid is solidified under a low temperature condition. The melting point thereof is more preferably about 20° C. or lower, and is further preferably about 10° C. or lower.

A boiling point of the ionic liquid is preferably equal to or higher than about 400° C. The boiling point thereof is more preferably equal to or higher than about 450° C., and is further preferably equal to or higher than about 500° C. If the boiling point is lower than 400° C., a coatability of the ionic liquid as the liquid sealing material may deteriorate.

A molecular weight of the ionic liquid is preferably less than about 1,000. The molecular weight thereof is more preferably less than about 750, and further preferably smaller than about 500. If the molecular weight is equal to or more than 1,000, the ionic liquid may not be properly coatable owing to its high viscosity.

Next, the ink used in the invention is described. Either of a water-based ink containing a water-based solvent as a solvent and an oil-based ink containing an oil-based solvent as a solvent can be used as the ink. A water-based ink is superior in view of safety since a main solvent thereof is a water-based solvent, while an oil-based ink has a good stability and less bleeding, and is superior in high-speed printing.

Examples of the water-based ink include an ink in which a water-soluble dye or a pigment is dispersed or dissolved as a coloring agent in a water-based solvent. Examples of the oil-based ink include an ink in which an oil-soluble dye is dissolved as a coloring agent in an oil-based solvent and an ink in which a dye or a pigment is dispersed as a coloring agent by treating the dye or the pigment to be an inverted micelle.

Either of a pigment and a dye can be used as the coloring agent. Examples of the pigment include inorganic pigments, organic pigments, magnetite, magnetic substances and paranormal magnetic substances, and plastic pigments and metalescent pigments. Any pigment can be used without being limited to the above specific examples. The pigments may have been surface-treated. Self-dispersible pigment can also be used in the solvent. The pigments may be microencapsulated by being contained in resins by a phase reversal of emulsion process, a coacervation process or the like. Examples of the dyes include water-soluble dyes (such as acid dyes, direct dyes or cationic dyes), oil-soluble dyes and disperse dyes.

Examples of the water-based solvent include water, and ion-exchange water, ultrapure water, distilled water or ultrafiltrate water is preferably used in view of particularly preventing contamination by impurities during mixing.

Examples of an available oil-based solvent include organic solvents such as aliphatic hydrocarbons, aromatic hydrocarbons, alcohols, ketones, esters, ethers, glycols, nitrogen-containing solvents and vegetable oils. Examples of the aliphatic hydrocarbons include n-hexane, cyclohexane, methylhexane, n-octane, methylheptane, dimethylhexane, nonane and decane, and n-paraffinic solvent such as isoper, iso-paraffinic solvent and paraffinic solvent such as cycloparaffinic solvent. Examples of aromatic hydrocarbon include toluene, ethyl benzene and xylene. Examples of he alcohols include methanol, ethanol, propanol, butanol, hexanol and benzyl alcohol. Examples of the ketones include acetone, methyl ethyl ketone, pentanone, hexanone, heptanone and cyclohexanone. Examples of the esters include methyl acetate, ethyl acetate, vinyl acetate, ethyl propionate and ethyl butyrate. Examples of the ethers include diethyl ether, ethylpropyl ether, ethylpropyl ether and ethylisopropyl ether. Examples of the glycols include ethylene glycol, diethylene glycol, propanediol, hexanediol, glycerin and polypropylene glycol. In addition thereto, glycol derivatives such as ethylene glycol methyl ether, ethylene glycol ethyl ether, ethylene glycol butyl ether, diethylene glycol ethyl ether or diethylene glycol butyl ether may be used as the solvent. Examples of the vegetable oils include drying oils, semi-drying oils and non-drying oils. Examples of the drying oils include a perilla oil, a linseed oil, a tung oil, a poppy oil, a walnut oil, a safflower oil and a sunflower oil. Examples of semi-drying oils include a rape oil, and examples of non-drying oils include a coconut oil. The above-mentioned solvents may be used singly or together in combination of two or more thereof.

Additives can be further added to ink in accordance with necessity. Examples of the additives include a water-soluble organic solvent, a dispersant, a pH adjustor, a hydrotropy agent, a chelating agent, a clathrate compound, an oxidizing agent, an antioxidant, a reducing agent, an enzyme, a germicide, an antifoaming agent and an abrasive.

A viscosity of the ink is preferably in a range of approximately 1 to 50 m Pa/s at a temperature of 20° C., more preferably in a range of approximately 1.2 to 40 m Pa/s and further more preferably in a range of approximately 1.5 to 25 m Pa/s. It is not preferable that the viscosity exceeds approximately 50 m Pa/s since an ejecting property of the ink may become unstable. It is also not preferable that the viscosity is being less than approximately 1 m Pa/s since such condition may cause a nozzle overflow. A surface tension of the ink is preferably in a range of approximately 20 to 45 mN/m at a temperature of 20° C. It is not preferable that the surface tension is being less than approximately 20 mN/m, since ejectability and preservation may be deteriorated under such a condition. It is also not preferable that the surface tension exceeds approximately 45 mN/m, since a permeability into papers as well as drying characteristics may be deteriorated and high-speed printability may be damaged under such a condition.

Next, the treating solution used in the invention is described. The treating solution has a function of flocculating ink components and is obtained by dispersing or dissolving a component which has the function of flocculating ink components in a solvent. By contacting the treating solution with the ink, ink components are flocculated and coloring property, optical density, and drying time of the ink are improved while solid portion unevenness, bleeding, and bleeding between colors are reduced. The treating solution may be provided so as to be mutually adjacent to or covering the ink, provided that the treating solution and the ink are contacted.

Examples of the component having the function of flocculating ink components include a flocculating agent which flocculates a coloring agent as an ink component. Examples of the flocculating agent include a substance having a function of increasing a particle diameter of at least a coloring agent, and a substance having a function of separating a coloring particulate component of the ink from the solvent, when mixed with ink. Specific examples thereof include an inorganic electrolyte, organic acid, inorganic acid and organic amine.

Examples of the inorganic electrolyte include salts of alkaline metal ions such as a lithium ion, a sodium ion, or a potassium ion; polyvalent metal ions such as an aluminum ion, a barium ion, a calcium ion, a copper ion, an iron ion, a magnesium ion, a manganese ion, a nickel ion, a tin ion, a titanium ion, or a zinc ion, and acids such as a hydrochloric acid, hydrobromic acid, hydroiodic acid, sulfuric acid, nitric acid, phosphoric acid, thiocyanic acid, organic carboxylic acids such as an acetic acid, oxalic acid, lactic acid, fumaric acid, citric acid, salicylic acid, or benzoic acid, or organic sulfonic acids.

Specific examples of the organic acid include an arginine acid, citric acid, glycine, glutamic acid, succinic acid, tartaric acid, cystine, oxalic acid, fumaric acid, phthalic acid, maleic acid, malonic acid, lysine, malic acid, and derivatives thereof. Examples of the organic acid further include compounds having a structure of a furan, pyrrole, pyrroline, pyrrolidone, pyron, thiophene, indole, pyridine, or quinoline and further having a carboxy group as a functional group.

Examples of the inorganic acid include an acetic acid, hydrochloric acid, nitric acid, sulfuric acid, phosphoric acid, boric acid, and phosphorous acid.

Primary, secondary, tertiary, or quaternary amines and any salts thereof can be used as the organic amine compounds. Examples thereof include a tetraalkyl ammonium, alkylamine, benzalkonium, alkylpyridium, imidazolium, polyamine, and derivatives and salts thereof.

Either of a water-based solvent and an oil-based solvent can be used as the solvent of the treating solution used in the invention. Examples of the water-based solvent include water, and ion-exchange water, ultrapure water, distilled water or ultrafiltrate water is preferably used in view of particularly preventing contamination by impurities during mixing. Similar solvents as used in the ink can be also used as the oil-based solvent the treating solution, and examples of the organic solvents include aliphatic hydrocarbons, aromatic hydrocarbons, alcohols, ketones, esters, ethers, glycols, nitrogen-containing solvent and vegetable oils.

As similar to the ink, additives can be further added to the treating solution in accordance with necessity. Examples of the additives include a water-soluble organic solvent, a dispersant, a pH adjustor, a hydrotropy agent, a chelating agent, a clathrate compound, an oxidizing agent, an antioxidant, a reducing agent, an enzyme, a germicide, an antifoaming agent and an abrasive. The treating solution can also be used as the ink by adding a coloring agent thereto.

The ionic liquid can also be contained in the ink and treating solution as described above. Further, the ionic liquid and can also be used as a solvent of the ink and treating solution.

Next, an ink jet recording process used in the invention is described. The ink jet recording process may be either a one-part liquid type in which the ink is used singly or a two-part liquid type in which the treating solution is used together therewith. In the case of the two-part liquid type, the ink and the treating solution having the function of flocculating components of the ink are ejected to a recording medium so as to be mutually contacted and form an image. The mutual contact between the ink and treating solution makes the ink components flocculate to give a recording system superior in coloring property, solid portion evenness, optical density, bleeding prevention, prevention of bleeding between colors, and drying time length. Provided that they are mutually contacted, the treating solution may be provided so as to be mutually adjacent to the ink or covering the ink.

A thermal ink jet recording process or a piezo-ink jet recording process is preferably adopted as the ink jet recording process used in the invention from the viewpoint of the effect of improving bleeding prevention and prevention of bleeding between colors. In the case of the thermal ink jet recording process, the ink is heated when it is ejected and thus acquires a low viscosity. However, the temperature of the ink is lowered when it is set on a recording medium and the viscosity of the ink drastically increases, leading to an effect of improving bleeding prevention and prevention of bleeding between colors. On the other hand, in the case of a piezo-ink jet recording process, liquid having a high viscosity can be ejected and restrained from spreading on a recording medium in a paper surface direction, leading to an effect of improving bleeding prevention and prevention of bleeding between colors.

The ink is preferably imparted to the recording medium after the treating solution is imparted to the recording medium. The reason why this imparting order is preferable is that the imparting order allows components in the ink to be effectively flocculated. After imparting the treating solution, the ink may be imparted to the recording medium at any time, preferably within about 1 second after imparting the treating solution and more preferably within about 0.5 seconds.

The liquid amount of the ink and treating solution respectively per drop thereof is preferably about 25 ng or less, more preferably about 0.5 to 20 ng and still more preferably about 2 to 8 ng. When the liquid amount per drop exceeds about 25 ng, the bleeding prevention property thereof occasionally deteriorates. This is assumed to be because the contact angle of the ink or treating solution with the recording medium changes depending on the quantity of liquid dropped, and the tendency for each drop to spread in the paper surface direction increases in accordance with an increase in the quantity of the liquid dropped. When drops of plural volumes can be ejected from one nozzle, however, the “quantity of the liquid dropped” signifies the minimum quantity of liquid dropped that is capable of printing.

A mass ratio of the amount of ink to the amount of treating solution imparted to form one pixel is preferably from approximately 1:20 to 20:1, more preferably from approximately 1:10 to 10:1 and still more preferably from approximately 1:5 to 5:1. When the imparted amount of the ink is too small or excessive relative to the imparted amount of the treating solution, the function of flocculating the ink components can be rendered insufficient, which causes reduction in optical density and deterioration of bleeding prevention and prevention of deterioration of bleeding between colors. “Pixel” as referred to herein is a dot constituted by dividing a desired image by the minimum distance required to impart the ink in a scanning direction and a sub-scanning direction. Color and image density are adjusted and an image is formed by imparting appropriate inks to each pixel.

The invention can be applied to formation of an image on permeable paper such as ordinary paper as well as impermeable media such as art paper, film or metal. The invention, therefore, can be employed in the fields of printed matter, techniques for producing electric wiring substrates, color filters, techniques for producing display devices such as a liquid crystal display or an organic EL display, medical film recording, DNA information recording, and building materials such as wall paper or decorative sheets.

The invention is most effective for an ink jet recording process, and can be also applied to printing systems such as offset printing, gravure printing, flexographic printing and screen printing.

### EXAMPLES

Examples 1-1 to 1-6, in which ionic liquids as liquid sealing materials are applied to nozzle faces of a test print head (a recording head: drop quantity of about 14 ng) having 600 dpi and 1024 nozzles, and Examples 2-1 to 2-2 for comparison with the above examples, in which liquid sealing materials other than ionic liquids are applied, are prepared and evaluated. The following compositions are used for the inks and the treating solutions to be used therein.

Compositions of Inks and Treating solution

Composition of Ink A

CABOJET®-300 (manufactured by Cabot Corporation): 4% by mass

Styrene—acrylic acid—sodium acrylate copolymer: 0.75% by mass

Diethylene glycol: 15% by mass

Glycerin: 5% by mass

Acetylene glycol ethylene oxide adduct: 1% by mass

Ion-exchange water: residue portion

Composition of Ink B

C. I. Pigment Blue-15:3:5% by mass

Benzylmethacrylate—laurylacrylate copolymer: 5% by mass

Diethyleneglycol monobuthylether: 50% by mass

Isopropyl alcohol: 40% by mass

Composition of Ink C

CABOJET®-300 (manufactured by Cabot Corporation): 4% by mass

Styrene—acrylic acid—sodium acrylate copolymer: 0.75% by mass

Diethylene glycol: 15% by mass

Glycerin: 5% by mass

Acetylene glycol ethylene oxide adduct: 1% by mass

1-ethyl-3-methylimidazolium bis(trifuloromethanesulfonyl)imide (ionic liquid: weight average molecular weight=391: m.p.-16° C.): 0.6% by mass

Ion-exchange water: residue portion

Composition of Ink D

CABOJET®-300 (manufactured by Cabot Corporation): 4% by mass

Styrene—acrylic acid—sodium acrylate copolymer: 0.75% by mass

Diethylene glycol: 15% by mass

Glycerin: 5% by mass

Acetylene glycol ethylene oxide adduct: 1% by mass

N,N-diethyl-N-methyl-N-(2-methoxyethyl)ammonium bis(trifuloromethanesulfonyl)imide (ionic liquid: weight average molecular weight=426: m.p. equal or lower than 25° C.): 0.3% by mass

Ion-exchange water: residue portion

Composition of Treating solution A

Diethylene glycol: 20% by mass

2-pyrrolidone-5-carboxylic acid: 5% by mass

Sodium hydroxide: 1% by mass

Acetylene glycol ethylene oxide adduct: 1% by mass

Ion-exchange water: residue portion

### Example 1-1

1-ethyl-3-methylimidazolium bis(trifluoromethanesulfonyl)imide (ionic liquid, a weight average molecular weight: 391, a melting point: about −16° C.) as a liquid sealing material is applied to a nozzle face of the recording head, which has been filled with each of the ink A and the treating solution A.

### Example 1-2

N-diethyl-3-methyl-N-(2-methoxyethyl)ammonium bis(trifluoromethanesulfonyl)imide (ionic liquid, a weight average molecular weight: 426, a melting point: equal to or less than about 25° C.) as a liquid sealing material is applied to a nozzle face of the recording head, which has been filled with each of the ink A and the treating solution A.

### Example 1-3

Piperidium inonic liquid (trade name: MP-200, manufactured by TREKSTAR, a weight average molecular weight: 422, a melting point: about 11° C.) as a liquid sealing material is applied to a nozzle face of the recording head, which has been filled with each of the ink A and the treating solution A.

### Example 1-4

N-diethyl-3-methyl-N-(2-methoxyethyl)tetrafluoroborate (ionic liquid, a weight average molecular weight: 233, a melting point: equal to or less than about 25° C.) as a liquid sealing material is applied to a nozzle face of the recording head, which has been filled with each of the ink A and the treating solution A.

Example 1-5 (Example of supplying the ionic liquid together with the ink)

### Example 1-5

Ink C is filled to a nozzle face of the recording head and applied for printing.

### Example 1-6

### Example of Supplying the Ionic Liquid Together with the Ink

Ink D is filled to a nozzle face of the recording head and applied for printing.

### Example 2-1

Dimethyl buthanol as a liquid sealing material is applied to a nozzle face of the recording head, which has been filled with each of the ink A and the treating solution A.

### Example 2-2

Ion-exchanged water as a liquid sealing material is applied to a nozzle face of the recording head, which has been filled with each of the ink A and the treating solution A.

The melting points of the above-mentioned ionic liquids are determined under the conditions in which they are kept at a temperature of about 23° C., and when in a liquid state under these conditions liquid, an ionic liquid is determined to have a melting point of about 25° C. or less. Alternatively, if the melting point of an ionic liquid is described in material physical properties tables or the like, the melting point thereof is taken to be the value described therein.

Solubility (the amount of the ionic liquid that can be solved in 100 g of the ink) is defined by mixing the ink and the ionic liquid in predetermined amounts and leaving the resultant mixture for 1 day while keeping it at a temperature of about 23° C. The amount of ionic liquid that has separated from the ink 1 day after mixing is determined as the amount of ionic liquid exceeding the solubility of the ionic liquid in the ink.

Evaluation

The evaluation is performed in the following manner. Predetermined ink and treating solution are filled into a recording head to observe printing in an initial state. Subsequently, the head is left for 30 days without maintenance such as cap under a general environment (temperature: 23±0.5° C., humidity: 55±5% RH). In Examples 1-1 to 1-4 and Examples 2-1 and 2-2, the heads are left in a state where each nozzle face is supplied with the ionic liquid, and meanwhile in Examples 1-4 and 1-5 and Example 2-3, the heads are left in a post-printing state. After leaving these for a predetermined period, printing is conducted after performing an ordinary starting operation of the printer so as to count the number of nozzles capable of properly performing printing.

The ratio of the number of nozzles which can perform normal injection after being thus left to the number of nozzles which can perform normal injection in the initial state is calculated, and evaluated on the basis of the following criteria.

Good: the ratio of injection nozzle number after leaving to that in the initial state is 95% or more;

Acceptable: the ratio of injection nozzle number after leaving to that in the initial state is 90% or more and less than 95%; and

Unacceptable: the ratio of injection nozzle number after leaving to that in the initial state is less than 90%.

TABLE 1

| | | | | Solubility (g) | |
|---|---|---|---|---|---|
| | | Solubility (g) of | | ionic liquid in | |
| | | of ionic liquid in 100 g | Treating | 100 g of treating | Injection |
| | Ink | of ink | solution | solution | nozzle ratio |
| Example 1-1 | A | less than 5 g | A | less than 5 g | Good |
| Example 1-2 | A | 0.1 g or less | A | 0.1 g or less | Good |
| Example 1-3 | A | less than 5 g | A | less than 5 g | Good |
| Example 1-4 | B | less than 5 g | — | — | Good |
| Example 1-5 | C | 0.1 g or less | — | — | Good |
| Example 1-6 | D | 0.1 g or less | — | — | Acceptable |
| Example 2-1 | A | — | A | — | Unacceptable |
| Example 2-2 | B | — | — | — | Unacceptable |

It is found from the results of the evaluation that the Examples in which the ionic liquid of the present invention are applied are capable of suppressing deterioration in ejectability by effectively preventing evaporation of the main components of solvents (such as water or an organic solvent) in image forming liquids (the ink and treating solution) over a long period.

What is claimed is:

1. A recording apparatus comprising an image forming liquid imparting device for imparting an image forming liquid to a recording medium, wherein an image forming liquid imparting port of the image forming liquid imparting device is provided with a supplying device for supplying at least one ionic liquid.

2. The recording apparatus of claim 1, wherein the supplying device mixes the ionic liquid with the image forming liquid in advance and supplies the ionic liquid together with the image forming liquid to the image forming liquid imparting port through the image forming liquid imparting device.

3. The recording apparatus of claim 2, wherein the amount of the ionic liquid to be mixed with the image forming liquid exceeds the solubility of the ionic liquid to the image forming liquid.

4. The recording apparatus of claim 3, wherein the amount of the ionic liquid that is soluble in 100 g of the image forming liquid is less than about 5 g.

5. The recording apparatus of claim 1, wherein the supplying device supplies the ionic liquid to the image forming liquid imparting port by coating.

6. The recording apparatus of claim 5, comprising a coating device that contacts a member, which is impregnated with the ionic liquid, with the image forming liquid imparting port of the image forming liquid imparting device in order to apply the ionic liquid.

7. The recording apparatus of claim 5, comprising a coating device that contacts the ionic liquid with the image forming liquid imparting port of the image forming liquid imparting device by an effect of an electric field in order to apply the ionic liquid.

8. The recording apparatus of claim 1, wherein the image forming liquid imparting device is used in an ink jet recording process.

9. The recording apparatus of claim 1, wherein the image forming liquid is an ink.

10. The recording apparatus of claim 1, wherein an ink and a treating solution that has a function of flocculating ink components are provided as the image forming liquid.

11. The recording apparatus of claim 1, wherein the ionic liquid is a compound comprising an organic cation and an anion and having a melting point of about 25° C. or lower.

12. The recording apparatus of claim 1, wherein the molecular weight of the ionic liquid is less than 1,000.

13. The recording apparatus of claim 11, wherein the organic cation comprises at least one selected from the group consisting of an imidazolium ion, a pyridinium ion, a peprtidinium ion, a quaternary ammonium ion, and a phosphonium ion.

14. The recording apparatus of claim 11, wherein the anion comprises at least one selected from the group consisting of a lithium ion, a bromine ion, a chlorine ion, a lactate ion, a hexafluorophosphate, a tetrafluoroborate, a bis(trifluoromethanesulfonyl)imide, and trifluoromethanesulfonate.
